(19) United States
(12) Patent Application Publication
(10) Pub. No.: US 2021/0341785 A1
(43) Pub. Date: Nov. 4, 2021

(54) DISPLAY PANEL

(71) Applicant: TCL CHINA STAR OPTOELECTRONICS TECHNOLOGY CO., LTD., Shenzhen (CN)

(72) Inventor: Shuo Qu, Shenzhen, Guangdong (CN)

(21) Appl. No.: 16/617,155

(22) PCT Filed: Nov. 12, 2019
(86) PCT No.: PCT/CN2019/117304

§ 371 Date: Nov. 26, 2019

(30) Foreign Application Priority Data
Aug. 23, 2019 (CN) 201910783364.4

(51) Int. Cl. G02F 1/1335; G02F 1/1339

(52) U.S. Cl. CPC G02F 1/133514; G02F 1/1339

(57) ABSTRACT

The present invention relates to a display panel, the present invention, by setting the sum of the areas of the supporting surfaces of the supporting columns of the unit area in the first region to be greater than the sum of the areas of the supporting surfaces of the supporting columns of the unit area in the second region, increases a compressible distance under the second region of the display panel such that a thickness of the cell easily reduces according to the volume of the liquid crystal to prevent generation of vacuum bubbles and poor quality of products and increase reliability of the products.

### FIELD OF INVENTION

The present invention relates to a field of display technologies, relates to a display panel.

### BACKGROUND OF INVENTION

A display device can convert data of a computer to display characters, numbers, symbols or intuitive images, and can use input tools such as a keyboard to input instructions or data into the computer to employ hardware or software to add, delete, and changes displayed contents anytime. Display devices, are classified into types of plasma displays, liquid crystal displays, light emitting diode displays, and cathode ray tube displays.

Main Liquid crystal displays (LCDs) are thin film transistor (TFT) LCDs, which are extension from original liquid crystal display technologies.

In a TFT-LCD active liquid crystal display, each sub-pixel has one TFT, a gate electrode thereof is connected a horizontal scan line, a drain electrode thereof is connected to a data line along a vertical direction, and a source electrode is connected to a pixel electrode. a sufficient voltage is applied to the horizontal scan line to switch on all TFTs on the horizontal scan line. At the meantime, the pixel electrode on the horizontal scan line is electrically conducted to the data line in the vertical direction such that a signal voltage on the data line is written in to the pixel. Orientations of liquid crystal molecules are controlled by changing the signal and voltage on the TFTs such that emission of polarized light of each pixel is controlled for purposes of display. TFT liquid crystal has a semiconductor switch disposed for each pixel such that each pixel can be controlled individually completely. The liquid crystal material is sandwiched between a TFT glass layer and a color filter layer, and orientations of liquid crystal molecules are controlled by changing a voltage value exciting the liquid crystal molecules such that emission of polarized light of each pixel is controlled for purposes of display. Therefore, finally displayed light intensity and color are controlled.

### Technical Issue

The TFT-LCD is assembled by an array substrate, a color substrate, and liquid crystal between the two substrates. Bonding of the two substrates is completed by a sealant frame. After curing, the sealant frame has no variation in volume, and a cell gap of a bezel of the display panel is basically constant, a cell gap of a central region of the display panel varies according to variation of a temperature and a pressure of the environment. At the present, reliability of the liquid crystal display panel in actual use is simulated in an environment of a low temperature, the display panel lies horizontally, and a volume thereof is reduced in a low temperature, which results reduction of the cell gap of the display panel. When the display panel is bent and the supporting columns are pressed and the pressure applied to the supporting columns and the sealant frame are equal to an atmosphere pressure, the liquid crystal cannot fill the cell, which results in vacuum bubble generated and filling the liquid crystal cell and causes poor quality of products. Therefore, it is necessary to seek a new display panel to solve the above issue.

### SUMMARY OF INVENTION

### Technical Solution

An objective of the present invention is to provide a display panel that can solve the issue that liquid crystal in a conventional display panel cannot fill a liquid crystal cell and generates vacuum bubbles in the liquid crystal cell to cause poor quality of the product.

To solve the above issue, an embodiment of the present invention provides a display panel defined with a first region and a second region, and comprising: an array substrate; a color substrate disposed on the array substrate; liquid crystal disposed between the array substrate and the color substrate; a sealant frame disposed around the liquid crystal; and supporting columns disposed between the array substrate and the color substrate, and arranged at intervals, wherein upper surfaces of the supporting columns contacting the color substrate are supporting surfaces; wherein a sum of areas of the supporting surfaces of the supporting columns of a unit area in the first region is greater than a sum of areas of the supporting surfaces of the supporting columns of a unit area in the second region.

Furthermore, the areas of the supporting surfaces of the supporting columns in the second region are all less than the areas of the supporting surfaces of the supporting columns in the first region.

Furthermore, an arrangement density of the supporting columns in the second region is less than an arrangement density of the supporting columns in the first region.

Furthermore, the areas of the supporting surfaces of the supporting columns in the first region are decreased gradually.

Furthermore, the intervals among the supporting columns in the first region are increased gradually.

Furthermore, the areas of the supporting surfaces of the supporting columns in the second region are decreased gradually.

Furthermore, the intervals among the supporting columns in the second region are increased gradually.

Furthermore, the areas of the supporting surfaces of the supporting columns are decreased gradually from the first region to the second region.

Furthermore, the intervals among the supporting columns are increased gradually from the first region to the second region.

### Advantages

The present invention relates to a display panel, the present invention, by setting the sum of the areas of the supporting surfaces of the supporting columns of the unit area in the first region to be greater than the sum of the areas of the supporting surfaces of the supporting columns of the unit area in the second region, increases a compressible distance under the second region of the display panel such that a thickness of the cell easily reduces according to the volume of the liquid crystal to prevent generation of vacuum bubbles and poor quality of products and increase reliability of the products.

### DESCRIPTION OF DRAWINGS

To more clearly elaborate on the technical solutions of embodiments of the present invention or prior art, appended figures necessary for describing the embodiments of the present invention or prior art will be briefly introduced as follows. Apparently, the following appended figures are merely some embodiments of the present invention. A person of ordinary skill in the art may acquire other figures according to the appended figures without any creative effort.

FIG. 1 is a schematic structural view of a display panel of the present invention.

FIG. 2 is a bottom view of a first embodiment of the present invention.

FIG. 3 is a cross-sectional view of the first embodiment of the present invention.

FIG. 4 is a bottom view of a second embodiment of the present invention.

FIG. 5 is a cross-sectional view of the second embodiment of the present invention.

FIG. 6 is a bottom view of a third embodiment of the present invention.

FIG. 7 is a cross-sectional view of the third embodiment of the present invention.

### REFERENCE NUMERALS IN THE DRAWINGS

100: display panel;
101: first region
102: second region
1: array substrate;
2: color substrate
3: liquid crystal;
4: sealant frame
5: supporting columns;
51: first supporting columns
52: second supporting columns

### DETAILED DESCRIPTION OF PREFERRED EMBODIMENTS

Preferred embodiments of the present invention are described with accompanying drawings as follows introduce a person of ordinary skill in the art the technical contents of the present invention completely such that examples are used to prove that the present invention can be embodied. As such, the published technologies of the present invention are made clearer such that a person of ordinary skill in the art can better understand the way to embody the present invention. However, the present invention can be embodied by embodiments of various forms, and the protective scope of the present invention is not only limited in the mentioned embodiment herein, and explanation of the following embodiments is not for limiting the scope of the present invention.

The terminologies of direction mentioned in the present invention, such as “upper”, “lower”, “front”, “rear”, “left”, “right”, “inner”, “outer”, “side surface”, etc., only refer to the directions of the appended figures. Therefore, the terminologies of direction are used for explanation and comprehension of the present invention, instead of limiting the present invention.

In the drawings, elements with the same structures are indicated with the same numerals, and elements with similar structures or functions are indicated with similar numerals. Furthermore, for convenience of understanding and description, the dimension and thickness of each assembly in the drawings are depicted at arbitrarily, and the present invention has no limit to the dimension and thickness of each assembly.

When some assemblies are described to be “on” another assembly, the assembly can be disposed directly on the another assembly; alternatively, the assembly can has an intervening assembly, the assembly is disposed on the intervening assembly, and the intervening assembly is disposed on the another assembly when an assembly are described to be “installed on” or “connected to” another assembly, both descriptions can be understood as directly “installed” or “connected”, or as one assembly “installed on” or “connected to” another assembly through an intervening assembly.

### First Embodiment

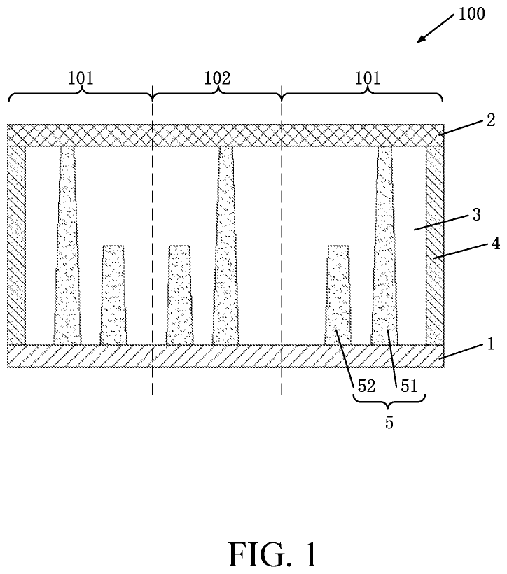

With reference to FIG. 1, a display panel 100 is defined with a first region 101 and a second region 102. The second region 102 is a central region, and the first region 101 surrounds the second region 102. The display panel 100 comprises: an array substrate 1, a color substrate 2, liquid crystal 3, a sealant frame 4, and supporting columns 5.

The color substrate 2 is disposed on the array substrate 1. The liquid crystal 3 is disposed between the array substrate 1 and the color substrate 2. The sealant frame 4 is disposed around the liquid crystal 3. The supporting columns 5 are disposed between the array substrate 1 and the color substrate 2 and are arranged at intervals.

The present embodiment defines an upper surface of each of the supporting columns 5 contacting the color substrate 2 as a supporting surface. a sum of areas of the supporting surfaces of the supporting columns 5 of a unit area in the first region 101 is greater than a sum of areas of the supporting surfaces of the supporting columns 5 of a unit area in the second region 102. As such, a compressible distance under the second region of the display panel is increased such that a thickness of the cell easily reduces according to the volume of the liquid crystal to prevent generation of vacuum bubbles and poor quality of products and increase reliability of the products.

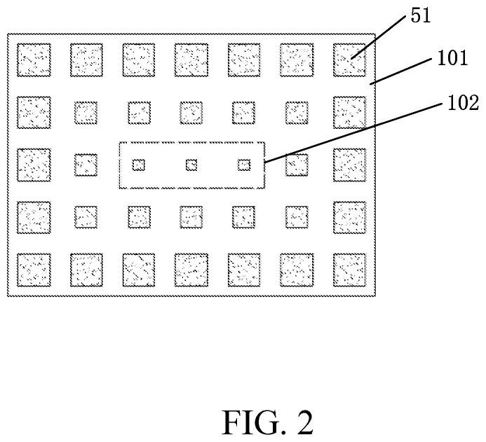

With reference to FIGS. 1 and 2, the supporting columns 5 comprises first supporting columns 51 and second supporting columns 52. A number of the first supporting columns 51 is less than a number of the second supporting columns 52. A height of each of the second supporting columns 52 is less than a height of each of the first supporting columns 51. Therefore, during an actual operation, the first supporting columns 51 mainly provide a supporting force. Thus, to make the display panel contract greatest according with the liquid crystal 3, it is necessary to lower the supporting force of the supporting columns 5. More specifically, it is necessary to lower the supporting force of the first supporting columns 51.

Specifically, the areas of the supporting surfaces of the first supporting columns 51 in the first region 101 can be decreased gradually along a direction toward the second region 102. Alternatively, the intervals among the first supporting columns 51 in the first region 101 can be increased gradually along the direction toward the second region 102. Alternatively, the areas of the supporting surfaces of the first supporting columns 51 in the second region 102 can be decreased gradually from a direction away from the first region 101. Alternatively, the areas of the supporting surfaces of the first supporting columns 51 in the second region 102 can be increased gradually along the direction away from the first region 101. It is to achieve that the sum of the areas of the supporting surfaces of the supporting columns 5 of the unit area in the first region 101 being greater than the sum of the areas of the supporting surfaces of the supporting columns 5 of the unit area in the second region 102. As such, a compressible distance under the second region of the display panel is increased such that a thickness of the cell easily reduces according to the volume of the liquid crystal to prevent generation of vacuum bubbles and poor quality of products and increase reliability of the products.

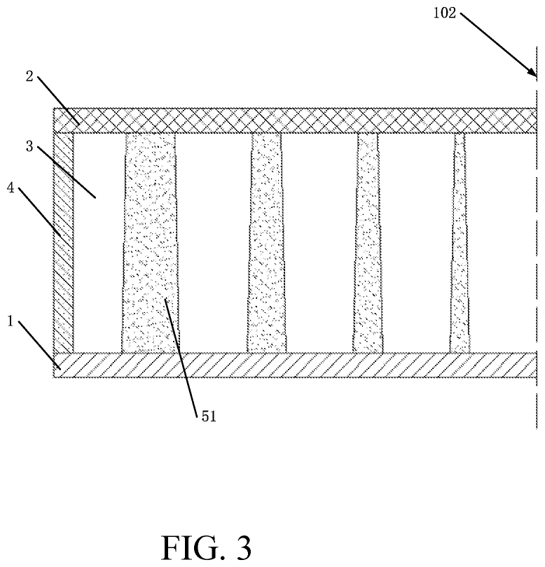

With reference to FIGS. 2 and 3, in the present embodiment, the areas of the supporting surfaces of the first supporting columns 51 in the second region 102 are all less than the areas of the supporting surfaces of the first supporting columns 51 in the first region 101.

With reference to FIGS. 2 and 3, the areas of supporting surfaces of the first supporting columns 51 are decreased gradually from a direction from the first region 101 to the second region 102. As such, the supporting force of the first supporting columns 51 can be reduced by lowering the supporting surfaces of the first supporting columns such that the display panel can contract greater to avoid generation vacuum bubbles, finally prevent poor quality of products and increase reliability of the products.

### Second Embodiment

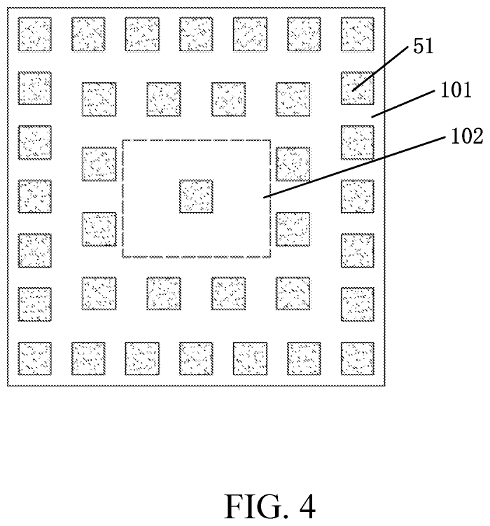

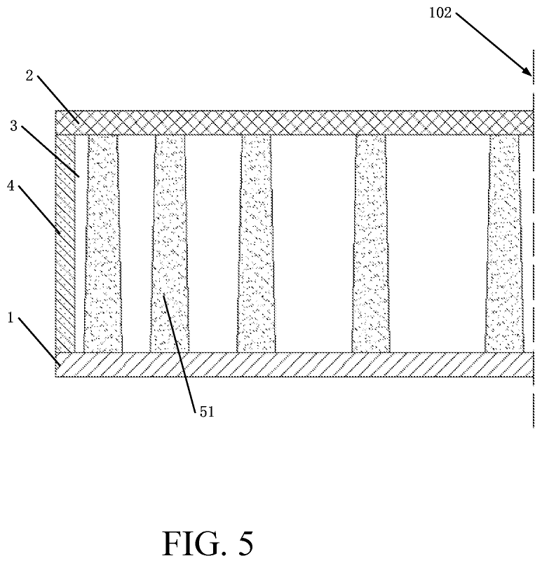

With reference to FIGS. 4 and 5, a difference of the second embodiment of the present invention from the first embodiment lies in that the areas of the supporting surfaces of the first supporting columns 51 are kept constant, an arrangement density of the first supporting columns 51 in the second region 102 is less than an arrangement density of the first supporting columns 51 in the first region 101 such that a supporting force of the first supporting columns 51 in the second region 102 under the display panel is reduced.

Specifically, the intervals among the first supporting columns 51 are increased from the first region 101 to the second region 102. As such the display panel can contract to a greater extent to avoid generation of vacuum bubbles, which finally prevents poor quality of products and raises reliability of the products.

### Third Embodiment

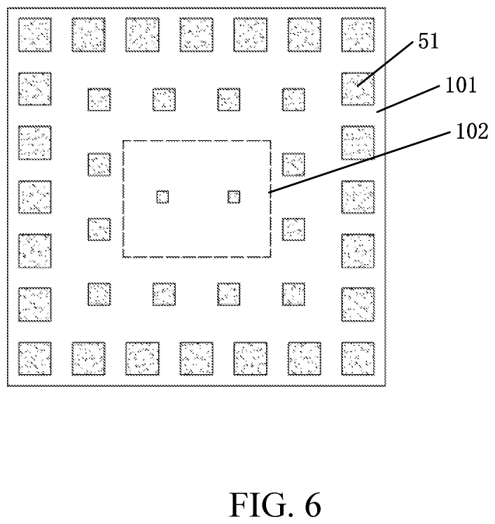

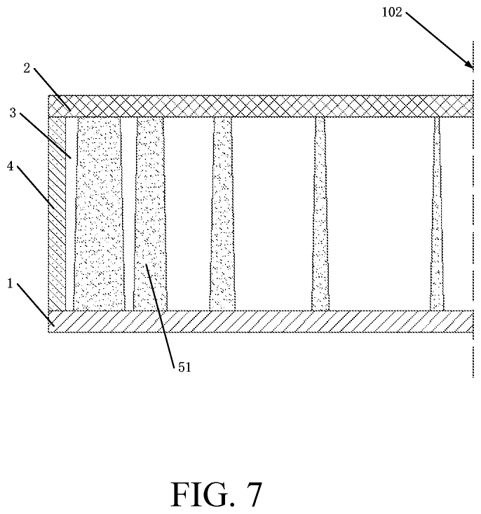

With reference to FIGS. 6 and 7, a difference of the third embodiment of the present invention from the first embodiment lies in that the areas of the supporting surfaces of the first supporting columns 51 in the second region 102 are less than the areas of the supporting surfaces of the first supporting columns 51 in the first region 101; furthermore, an arrangement density of the first supporting columns 51 in the second region 102 is less than an arrangement density of the first supporting columns 51 in the first region 101.

In other words, the areas of the supporting surfaces of the first supporting columns 51 from the first region 101 to the second region 102 are decreased gradually, and at the same time the arranging intervals among the first supporting columns 51 are increased gradually such that the display panel can contract greater to prevent generation of vacuum bubbles and poor quality of products and increase reliability of the products.

As described above, the display panel of the present invention are introduced in details. It should be understood that the exemplary embodiments herein should be considered descriptive for assisting understanding the methods and core concept of the present invention instead of being used for limiting the present invention. In each exemplary embodiment, description to characteristics or aspects should be deemed to description to similar characteristics or aspects in other exemplary embodiment. Although the exemplary embodiment describes the present invention, a person of ordinary skill in the art can be suggested to implement various modifications and changes. The present invention is intended to cover such modifications and changes as claimed in the claims. Any changes, equivalents for replacement and improvement in the spirit and principle of the present invention should be within the protective scope of the present invention.

What is claimed is:

1. A display panel, defined with a first region and a second region, and comprising:
an array substrate;
a color substrate disposed on the array substrate;
liquid crystal disposed between the array substrate and the color substrate;
a sealant frame disposed around the liquid crystal; and
supporting columns disposed between the array substrate and the color substrate, and arranged at intervals, wherein upper surfaces of the supporting columns contacting the color substrate are supporting surfaces;
wherein a sum of areas of the supporting surfaces of the supporting columns of a unit area in the first region is greater than a sum of areas of the supporting surfaces of the supporting columns of a unit area in the second region.

2. The display panel as claimed in claim 1, wherein the areas of the supporting surfaces of the supporting columns in the second region are all less than the areas of the supporting surfaces of the supporting columns in the first region.

3. The display panel as claimed in claim 1, wherein an arrangement density of the supporting columns in the second region is less than an arrangement density of the supporting columns in the first region.

4. The display panel as claimed in claim 1, wherein the areas of the supporting surfaces of the supporting columns in the first region are decreased gradually.

5. The display panel as claimed in claim 1, wherein the intervals among the supporting columns in the first region are increased gradually.

6. The display panel as claimed in claim 1, wherein the areas of the supporting surfaces of the supporting columns in the second region are decreased gradually.

7. The display panel as claimed in claim 1, wherein the intervals among the supporting columns in the second region are increased gradually.

8. The display panel as claimed in claim 1, wherein the first region is disposed around the second region.

9. The display panel as claimed in claim 8, wherein the areas of the supporting surfaces of the supporting columns are decreased gradually from the first region to the second region.

10. The display panel as claimed in claim 8, wherein the intervals among the supporting columns are increased gradually from the first region to the second region.
